(19) United States
(12) Patent Application Publication
(10) Pub. No.: US 2004/0184917 A1
(43) Pub. Date: Sep. 23, 2004

(54) Fastening of blades

(76) Inventor: Gerhard Brueckner, Altomuenster (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/480,164

(22) PCT Filed: Apr. 25, 2002
(86) PCT No.: PCT/DE02/01509

(51) Int. Cl. F03B 3/12

(52) U.S. Cl. 416/204 R

(57) ABSTRACT

Fastening of moving blades to a disk of a turbomachine rotor, having moving-blade roots which have a mirror-symmetrical cross section with projections, having axial disk slots holding the moving-blade roots in a positive-locking manner, and having one riveted joint per moving blade for axially fixing the latter.

Each blade root and the disk, in the region of each moving-blade root, have axial extensions, the extensions of moving blade and disk are opposite one another in pairs, in each case a hole lying in a radial plane relative to the disk axis is formed half in the extension of the moving blade and half in the extension of the disk, and a rivet is inserted into each hole and fixed by plastic deformation.

The invention relates to the fastening of moving blades to a disk of a turbomachine rotor according to the preamble of patent claim 1.

It is normal practice to provide turbine moving blades of gas turbines with toothed or wavelike roots, often referred to as “fir-tree roots”, and to hold these roots in axial disk slots in a positive-locking manner. The contact surfaces of root and slot absorb the radial centrifugal force and also flow- and acceleration-induced circumferential forces and bending moments. The axial forces have to be transmitted by additional elements. There are a number of possibilities for this, such as, for example, stop surfaces on one side of the blade roots, and plates, rings, wires, etc., which catch in slots on the other side of the blade roots in a positive-locking manner. Screwed fastenings are also known, screw holes and threads in the highly loaded disks being very critical from a strength point of view.

DE 195 16 694 A1 discloses fastening of the generic type which provides a riveted joint for absorbing the axial forces. There is one rivet per moving blade, and this rivet is directed axially between moving-blade root and disk-groove bottom from one end face to the opposite end face of the disk. The two rivet heads rest on seating plates which can compensate for small dimensional tolerances between blade and disk. During the disk exchange, the rivet heads can be removed, for example by drilling, without the risk of damaging the disk or the blade. The relatively inexpensive seating plates are renewed in any case, so that damage to them during the removal of the rivet is not important. It is admitted that this solution is relatively simple, inexpensive and easy to assemble and repair. One disadvantage, however, is that the disk slots in relation to the blade root have to be deeper than without a rivet or that there is room for only one rivet of relatively small cross section. A further, more serious disadvantage lies in the fact that the axial forces in the region of the seating plates are directed into the rivet heads, in the course of which the entire rivet head is under tensile stress. There is an acute risk of fracture under tensile stress due to the notch effect at the shank/head transitions. At least plastic deformations may occur, which increasingly loosen the joint. Against this background, the object of the present invention is to provide moving-blade fastening having a riveted joint, which fastening, with a moderate design outlay and considerable ease of assembly and repair and also a small space requirement, is markedly better in terms of strength and is therefore safer and more reliable.

This object is achieved by the features characterized in patent claim 1, in combination with the features in its preamble which establish the generic type. The essence of the invention lies in the fact that each rivet is arranged in a radial plane relative to the rotation axis of the disk and thus transversely to the axial forces which occur. Therefore only the rivet shank is subjected to shearing load; the rivet heads are free of load to the greatest possible extent. Tensile forces occur, if at all, only in a magnitude which does not present a problem, since they only result from acceleration forces and centrifugal forces from the low rivet mass. Rivets having a relatively large shank diameter, i.e. large thickness, can be used, with the advantage of low surface pressure and small shearing stresses in the shank. The “hole halves” in the extensions of the moving-blade roots and of the disks enclose the rivet shanks to the greatest possible extent and provide for a favorable introduction of force.

Preferred configurations of the fastening according to the invention are characterized in the subclaims.

The invention is explained in more detail below with reference to the drawings. In the drawings, in a simplified representation not to scale:

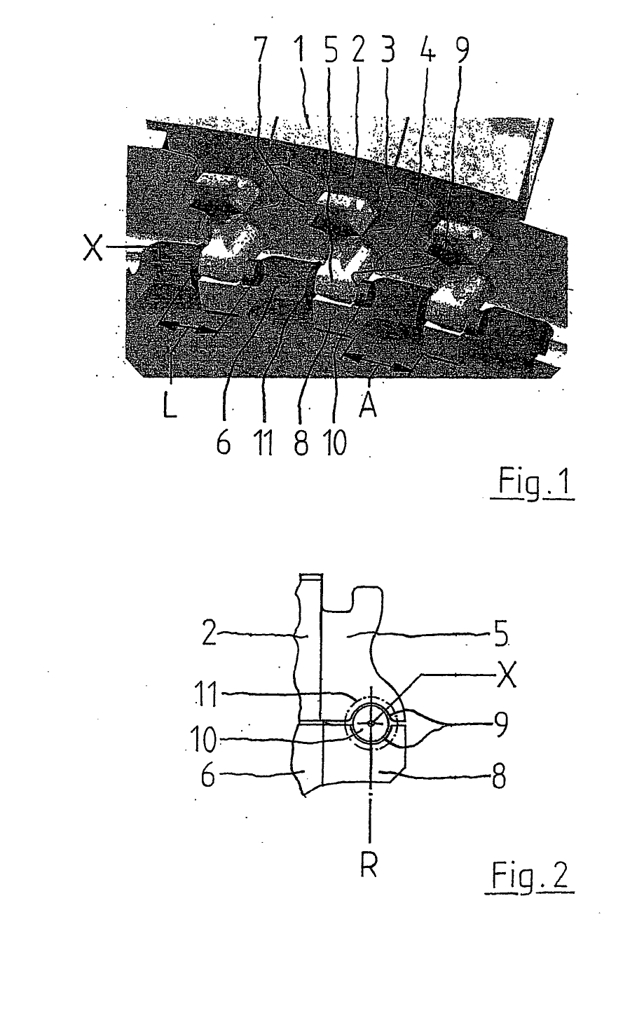

FIG. 1 shows a three-dimensional partial view of the fastening region of three moving blades on a disk, and

FIG. 2 shows a partial view of the region of the rivet fastening in the longitudinal direction of the rivet.

FIG. 1 is the copy of a three-dimensional computer graphic representation which, taking three moving blades 1 on a disk 6 as an example, shows the fastening according to the invention. Of the moving blades 1, in each case only the platform close to the disk, i.e. the inner annular space boundary, and the moving-blade root 2 can be seen. The respective airfoil lies above the representation. Each moving-blade root 2 is designed fir-tree-like in cross section with two mirror-symmetrical projections 3, 4 on each side and is held in a positive-locking manner by a disk slot 7. As a rule, the disk slots 7 run axially, but they may also be disposed at a small angle to the axial direction by defined rotation about an imaginary radial axis, e.g. the fitting axis of the blade profiles. However, this is of no importance for the principle of the invention.

The moving-blade roots 2 and the disk 6 have axial extensions 5, 8 which in each case are opposite one another in pairs. Formed in a pair of extensions 5, 8 is a common hole 9, into which a rivet 10 is inserted and fixed by plastic deformation. As an example, rivets 10 having a countersunk head 11 are shown in the still undeformed state in FIG. 1. The axes X of the holes 9 and thus of the rivets 10 lie tangentially on an imaginary circle (not shown) concentric to the rotation axis of the disk 6. The smallest distance A in the circumferential direction between the extensions 8 at adjacent blade positions is greater than the length L of an undeformed rivet 10 in order to be able to fit and rivet the latter. In this case, the space required by the riveting tool is also to be taken into account. In deviation from the tangential orientation shown of the hole and rivet axes X, said hole and rivet axes X may also be oriented in their common radial plane in any desired angular position between tangential and radial and also in a purely radial position. In this case, the extensions also ought to be adapted in their position if need be. Inclinations right up to radial arrangements may result in advantages in terms of assembly, although centrifugal force components then act in the rivet longitudinal direction and lateral forces also act on the moving-blade roots. However, it is ultimately decisive for absorbing the axial blade forces that the hole and rivet axes remain in a common radial plane relative to the disk axis. Of course, the axis orientation relative to the local tangential or radial direction is to be identical for each rivet at the disk circumference.

For further clarification, FIG. 2 shows a partial view in the direction of the X axis of the hole 9 and thus of the rivet 10. Indicated vertically by chain line is the radial plane R, which is disposed transversely to the rotation axis of the disk 6 and in which the axes X of all the holes 9 and rivets 10 are to lie, here with tangential orientation as in FIG. 1. It can be seen that the axial extension 5 of the moving-blade root 2 and the axial extension 8 of the disk 6 are opposite one another at a slight radial distance apart. It can also be seen that the hole 9 is in each case formed half in the extension 5 and half in the extension 8, the rivet 10 being enclosed to the greatest possible extent. The countersunk head 11 of the rivet 10 is indicated here by dot-dash line. It has already been mentioned that rivets having various head shapes can be used. In this case, it is to be taken into account that the rivets have to be capable of being removed/exchanged without damaging blades and disk. Countersunk-head-like rivets are in this case probably easier to grip and cut off than heads with large, flat bearing surfaces.

1. Fastening of moving blades to a disk of a turbomachine rotor, in particular of turbine moving blades to a disk of a gas turbine rotor, having moving-blade roots which, at least over most of their axial length, have a constant cross section with mirror-symmetrical toothlike or wavelike projections, having at least mainly axially running disk slots holding the moving-blade roots in a positive-locking manner in the radial direction and in the circumferential direction, and having in each case one riveted joint per moving blade for axially fixing the latter to the disk, characterized in that both each moving-blade root (2) and the disk (6), in the region of each moving-blade root (2), in each case have an axial, integral extension (5, 8), in that the extensions (5, 8) of moving blade (1) and disk (6) are opposite one another in pairs at a slight distance apart or in mutual contact, in that in each case a hole (9) lying with its axis (X) in a radial plane (R), i.e. in a transverse plane relative to the rotation axis of the disk (6), is formed approximately half in the extension (5) of the moving-blade root (2) and approximately half in the extension (8) of the disk (6), and in that a rivet (10) is inserted into each hole (9) and fixed by plastic deformation.

2. The fastening as claimed in claim 1, characterized in that all the holes (9) formed in the extension (5) of the moving-blade roots (2) and in the extensions (8) of the disk (6), with their axes (X), relative to the rotation axis of the disk (6), are oriented in the same manner either tangentially or with defined inclination with tangential and radial components or radially.

3. The fastening as claimed in claim 2 with tangentially oriented holes, characterized in that the extensions (5, 8), arranged in pairs, of the moving-blade roots (2) and of the disk (6) are at a minimum distance (A) apart in the circumferential direction from one blade position to an adjacent blade position, this distance (A) being greater in a defined manner than the length (L) of an undeformed rivet (10).

4. The fastening as claimed in one of claims 1 to 3, characterized in that rivets having a button head and flat head-bearing surface or rivets (10) having a countersunk head (11) are used, it being possible in the latter case for the holes (9) to be provided with a matching countersink on the rivet-head side.

5. The fastening as claimed in one or more of claims 1 to 4, characterized in that commercially available standard rivets are used.

6. The fastening as claimed in one or more of claims 1 to 5, characterized in that the rivet material has a lower mechanical strength and hardness than the material of the moving blade and the material of the disk in each case in the region of the extensions (5, 8).
